(19) United States
(12) Patent Application Publication
(10) Pub. No.: US 2026/0311211 A1
(43) Pub. Date: Oct. 8, 2026

(54) CONTENT INTEREST DEGREE PROCESSING DEVICE, TERMINAL DEVICE, AND PROGRAM

(71) Applicant: Coamix Inc., Tokyo (JP)

(72) Inventors: Nobuhiko HORIE, Musashino-shi (JP); Takeshi HANADA, Musashino-shi (JP); Taiyo NAKASHIMA, Musashino-shi (JP)

(73) Assignee: Coamix Inc., Tokyo (JP)

(21) Appl. No.: 19/482,340

(22) PCT Filed: Jun. 11, 2024
(86) PCT No.: PCT/JP2024/021232

§ 371 Date: Nov. 7, 2025

(30) Foreign Application Priority Data
Jul. 25, 2023 (JP) 2023-120607

(51) Int. Cl. G06Q 30/0242

(52) U.S. Cl. CPC G06Q 30/0245

(57) ABSTRACT

A content interest degree processing device includes a progress degree acquiring unit configured to acquire progress degree information on a degree of progress of content which progresses on the basis of a user's operation, an interest degree acquiring unit configured to acquire a real-time change of a degree of interest of a user to whom the content has been presented in the content, and a content interest degree information generating unit configured to generate content interest degree information in which the progress degree information acquired by the progress degree acquiring unit and the real-time change of the degree of interest acquired by the interest degree acquiring unit are correlated.

### TECHNICAL FIELD

The present invention relates to a content interest degree processing device, a terminal device, and a program.

Priority is claimed on Japanese Patent Application No. 2023-120607, filed Jul. 25, 2023, the content of which is incorporated herein by reference.

### BACKGROUND ART

In the related art, there are techniques of measuring physical quantities emitted from a human body such as a heart beat, brain waves, an electro-oculogram, the electrodermal activity, the skin temperature, and an electromyogram of a test subject and applying information on a user's autonomic neural activities in response to viewing of content or the like. For example, analyzing autonomic neural activities on the basis of an image in which a face of a user to whom content is presented is captured and evaluating the user's mental state about the content on the basis of the analyzed autonomic neural activities are performed (for example, see Patent Document 1).

### CITATION LIST

### Patent Document

Patent Document 1: Japanese Unexamined Patent Application, First Publication No. 2020-005799

### SUMMARY OF INVENTION

### Technical Problem

However, regarding content which progresses on the basis of a user's operation, the progress speed of the content varies between users. Since a user's operations cannot be said to be performed at a constant speed, the progress status of content and the elapsed time from starting of the content may have no specific correlation. When the progress speed varies between users and the progress status of content is not proportional to the elapsed time from starting of the content, it is difficult to collect data from a plurality of users and to identify a part in which a user's mental state changes in content (for example, a part in which a user is interested in content). Accordingly, regarding content which progresses on the basis of a user's operation, it may be difficult to analyze a change in a user's mental state and to evaluate a part in which a user's mental state changes in the content.

Therefore, an objective of the present invention is to evaluate a part in which a user's mental state changes in content regardless of individual differences in the progress speeds of content between users.

### Solution to Problem

[1] According to an aspect of the present invention, there is provided a content interest degree processing device including: a progress degree acquiring unit configured to acquire progress degree information on a degree of progress of content which progresses on the basis of a user's operation; an interest degree acquiring unit configured to acquire a real-time change of a degree of interest of a user to whom the content has been presented in the content; and a content interest degree information generating unit configured to generate content interest degree information in which the progress degree information acquired by the progress degree acquiring unit and the real-time change of the degree of interest acquired by the interest degree acquiring unit are correlated.
[2] In an aspect of the present invention, the content interest degree processing device according to [1] further includes a content time density information generating unit configured to, when the content is divided into a plurality of units, generate content time density information by correlating a time density indicating a time required for progress of one unit with the content interest degree information.
[3] In an aspect of the present invention, in the content interest degree processing device according to [1] or [2], the progress degree information includes information on a real-time change of the degree of progress, and the content interest degree information generating unit generates the content interest degree information by correlating the real-time change of the degree of progress acquired by the progress degree acquiring unit with the real-time change of the degree of interest acquired by the interest degree acquiring unit.
[4] In an aspect of the present invention, in the content interest degree processing device according to any one of [1] to [3], the degree of interest is based on a value which is acquired according to autonomic neural activity of the user to whom the content has been presented.
[5] In an aspect of the present invention, the content interest degree processing device according to any one of [1] to [4] further includes a normalization unit configured to normalize the degree of progress in a plurality of pieces of the content interest degree information generated by the content interest degree information generating unit when there are a plurality of pieces of content.
[6] In an aspect of the present invention, in the content interest degree processing device according to any one of [1] to [5], when the content is divided into a plurality of units, the units into which the content is divided are presented to the user one by one, and the progress degree information includes information indicating the degree of progress of each unit based on identification information for identifying each unit.
[7] In an aspect of the present invention, in the content interest degree processing device according to any one of [1] to [6], when the content is divided into a plurality of units, identification information for identifying each of the units into which the content is divided is provided, and the progress degree information includes information indicating the degree of progress of each unit based on the identification information.
[8] In an aspect of the present invention, in the content interest degree processing device according to any one of [1] to [7], when parts of the content are sequentially presented to the user, information included in a presentation range of the content in information included in the content is presented to the user by moving the presentation range in a predetermined direction on the basis of the user's operation, and the degree of progress is based on the ratio of the information included in the presentation range to the information included in the content.
[9] In an aspect of the present invention, in the content interest degree processing device according to any one of [1] to [8], a time required for the user to view a video of the content presented to the user is able to be changed by the user, and the progress degree information includes information on the degree of progress based on the ratio of a scale of the content from start of the video to a part currently viewed by the user to a scale of the whole video.
[10] According to another aspect of the present invention, there is provided a terminal device including: a progress degree acquiring unit configured to acquire progress degree information on a degree of progress of content which progresses on the basis of a user's operation; an interest degree acquiring unit configured to acquire a real-time change of a degree of interest of a user to whom the content has been presented in the content; a content interest degree information generating unit configured to generate content interest degree information in which the progress degree information acquired by the progress degree acquiring unit and the real-time change of the degree of interest acquired by the interest degree acquiring unit are correlated; and an output unit configured to output the content interest degree information.
[11] In an aspect of the present invention, the terminal device according to [10] further includes an autonomic neural activity acquiring unit configured to acquire a value based on autonomic neural activity of the user to whom the content has been presented, and the interest degree acquiring unit acquires the real-time change of the degree of interest on the basis of the value acquired by the autonomic neural activity acquiring unit.
[12] According to another aspect of the present invention, there is provided a program causing a computer to perform: a progress degree acquiring step of acquiring progress degree information on a degree of progress of content which progresses on the basis of a user's operation; an interest degree acquiring step of acquiring a real-time change of a degree of interest of a user to whom the content has been presented in the content; a content interest degree information generating step of generating content interest degree information in which the progress degree information acquired in the progress degree acquiring step and the real-time change of the degree of interest acquired in the interest degree acquiring step are correlated; and an output step of outputting the content interest degree information.

### Advantageous Effects of Invention

According to the present invention, it is possible to evaluate a part in which a user's mental state changes in content regardless of individual differences in a progress speed of content between users.

### BRIEF DESCRIPTION OF DRAWINGS

FIG. 1 A first diagram illustrating an example of content according to an embodiment.

FIG. 2 A block diagram of a system according to the embodiment.

FIG. 3 A functional configuration diagram illustrating an example of a functional configuration of a content interest degree processing device according to the embodiment.

FIG. 4 A diagram illustrating an example of a process flow of generating content time density information that is performed by the content interest degree processing device according to the embodiment.

FIG. 5 A diagram illustrating normalization of content interest degree information that is performed by the content interest degree processing device according to the embodiment.

FIG. 6 A second diagram illustrating an example of content according to the embodiment.

FIG. 7 A diagram illustrating an example of a terminal device that operates as the content interest degree processing device according to the embodiment.

FIG. 8 A functional configuration diagram illustrating an example of a functional configuration of a terminal device according to the embodiment.

FIG. 9 A flowchart illustrating an example of a process flow that is performed by the terminal device according to the embodiment.

### DESCRIPTION OF EMBODIMENTS

### Embodiments

Hereinafter, a content interest degree processing device, a terminal device, and a program according to an embodiment of the present invention will be described in conjunction with preferable examples with reference to the accompanying drawings. The present embodiment is not limited to the examples and includes various modifications or improvements added thereon. That is, constituents described below include constituents likely to be assumed by those skilled in the art and substantially equivalent constituents, and the constituents described below can be appropriately combined. The present invention can have various omissions, substitutions, or alterations of constituents applied thereto without departing from the gist of the present invention.

### First Content

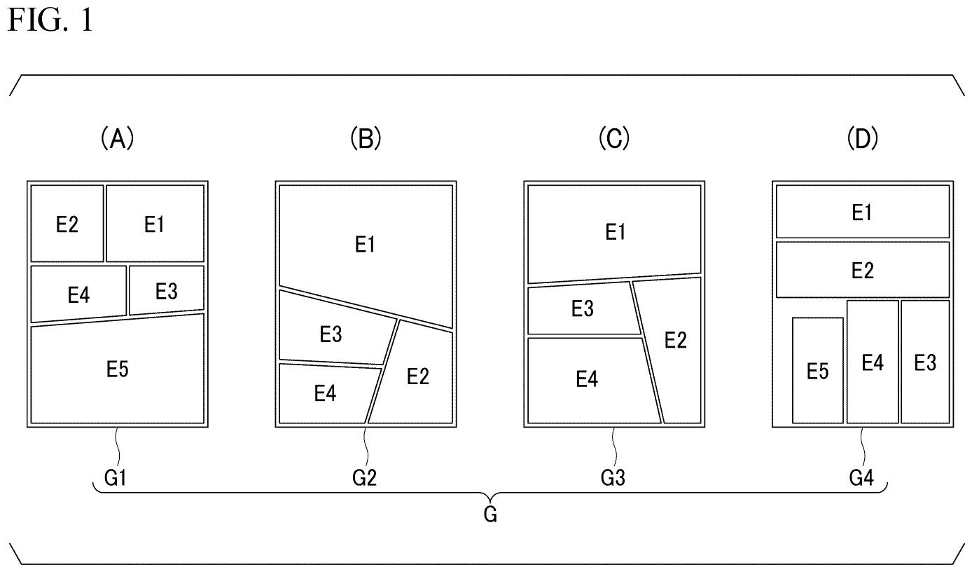

FIG. 1 is a first diagram illustrating an example of content according to an embodiment. First content which is an example of content will be described with reference to the drawing. The first content includes a plurality of groups G and is presented to a user for each group G. In the illustrated example, the first content is a cartoon (comics), and the group G is one page of a cartoon. In the illustrated example, the first content includes groups GI to G4. In the following description, the groups G1 to G4 may be simply referred to as groups G when they are not distinguished. The number of groups G may vary depending on content that is presented to a user. Specifically, the number of groups G constituting content may be preset to, for example, 200 or 300 or may be changed on the basis of a user's operation. Regarding content in which characters, illustrations, or the like are presented to a user, one group G may correspond to, for example, one page. In case of content in which a plurality of images or videos are presented to a user such as a social networking service (SNS) that can deliver images or a video, one group G may be, for example, one image or one video.

Each group G may include a plurality of elements E. In the illustrated example, the group G1 includes elements E1 to E5. In the following description, the elements El to E5 may be simply referred to as elements E when they are not distinguished. The groups G2 to G4 include a plurality of elements E similarly to the group G1. In case of content such as a cartoon, each element E may be, for example, one scene. In case of content such as a magazine, each element E may be, for example, a title. The number of elements E constituting a group G may be preset to, for example, 5 or 10 or may be changed on the basis of a user's operation. In case of content in which a plurality of videos are presented to a user such as an SNS that can deliver images or videos, each element E may be, for example, one frame of a video that is presented to a user,

### Content Interest Degree Processing Device

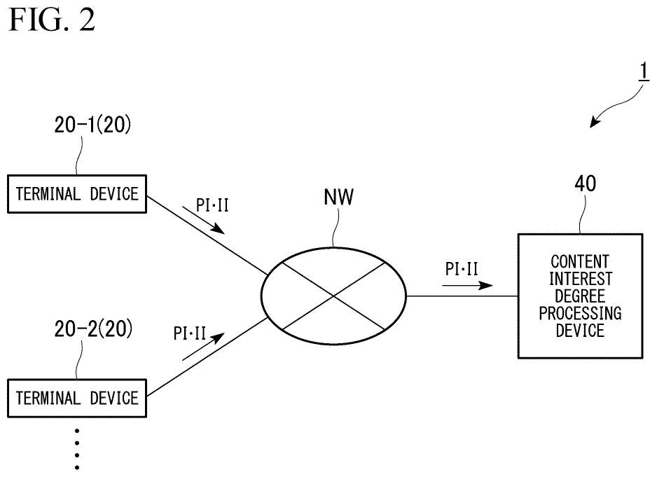

A content interest degree processing device according to an embodiment will be described below with reference to FIGS. 2 to 5.

FIG. 2 is a block diagram of a system according to the embodiment. An example of a system I according to the embodiment will be described below with reference to the drawing. The system I includes a plurality of terminal devices 20 and a content interest degree processing device 40. A terminal device 20-1 and a terminal device 20-2 illustrated in the drawing are examples of the plurality of terminal devices 20. The plurality of terminal devices 20 and the content interest degree processing device 40 are connected to each other via a network NW. An example of the network NW is the Internet. A predetermined communication network is an open network, and devices connected to the communication network can communicate with each other using predetermined protocols. In an Internet layer of the communication network, communication using the Internet protocol (IP) is performed.

Each terminal device 20 is operated by a user. The terminal device 20 provides content to the user on the basis of the user's operation. Examples of content provided by the terminal device 20 specifically include a cartoon, an electronic book, a picture-story show, a video, and various types of SNS. The terminal device 20 may be, for example, a personal computer, a tablet computer, or a smartphone in which an application that can provide content such as a cartoon reader (a comic viewer) that can present a cartoon is installed.

The terminal device 20 acquires progress degree information PI and interest degree information II. The progress degree information PI includes information on a degree of progress of content which progresses on the basis of the user's operation. The degree of progress may be, for example, a value based on identification information for identifying a group G or an element E presented to the user out of the groups G and the elements E constituting the content. The degree of progress is acquired, for example, from log data stored in the terminal device 20 or the like. The interest degree information II includes information on a degree of interest (which may be hereinafter referred to as an interest degree) of the user in the presented content. The terminal device 20 transmits the progress degree information PI and the interest degree information II to the content interest degree processing device 40 via the network NW. For example, the terminal device 20 may be a device such as a personal computer, a tablet computer, or a smartphone. The interest degree information II may be acquired on the basis of a value measured by an independent sensing device or the like which is separate from the terminal device 20 or may be acquired on the basis of a value measured by the terminal device 20 and a value measured by the sensing device or the like.

The progress degree information PI may include information indicating a real-time change of the degree of progress of the content. The degree of progress may be, for example, a value based on a page number for identifying a group G which is a page currently presented to the user or a number for identifying an element E which is a scene of a cartoon presented to the user or a value based on a volume number currently presented to the user. The degree of progress may be, for example, the ratio of the groups G or the element E presented to the user to the whole content. The interest degree information II may include, for example, information indicating a real-time change of the degree of interest of the user in the content.

The content interest degree processing device 40 acquires the progress degree information PI and the interest degree information II from each of the plurality of terminal devices 20. The content interest degree processing device 40 generates content interest degree information PII on the basis of the acquired progress degree information PI and the acquired interest degree information II. The content interest degree information PII includes information in which the progress degree information PI and the interest degree information II are correlated. The content interest degree processing device 40 is realized, for example, using a computer and software. The content interest degree processing device 40 may be realized using an electronic circuit according to necessity. The content interest degree processing device 40 may be an independent device, and at least some of the constituents of the content interest degree processing device 40 may be realized as an independent device. At least some of the functions which are realized by the content interest degree processing device 40 may be realized by cloud computing.

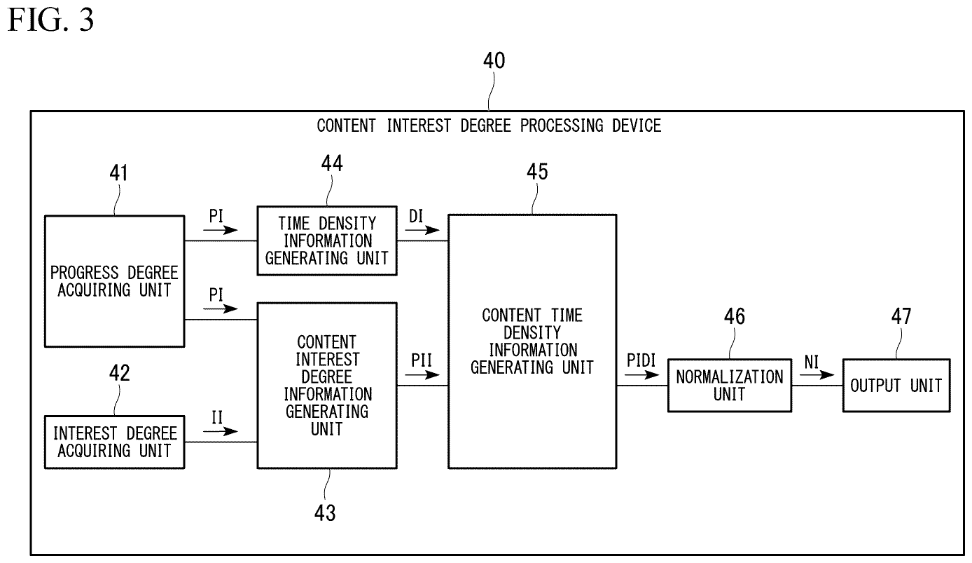

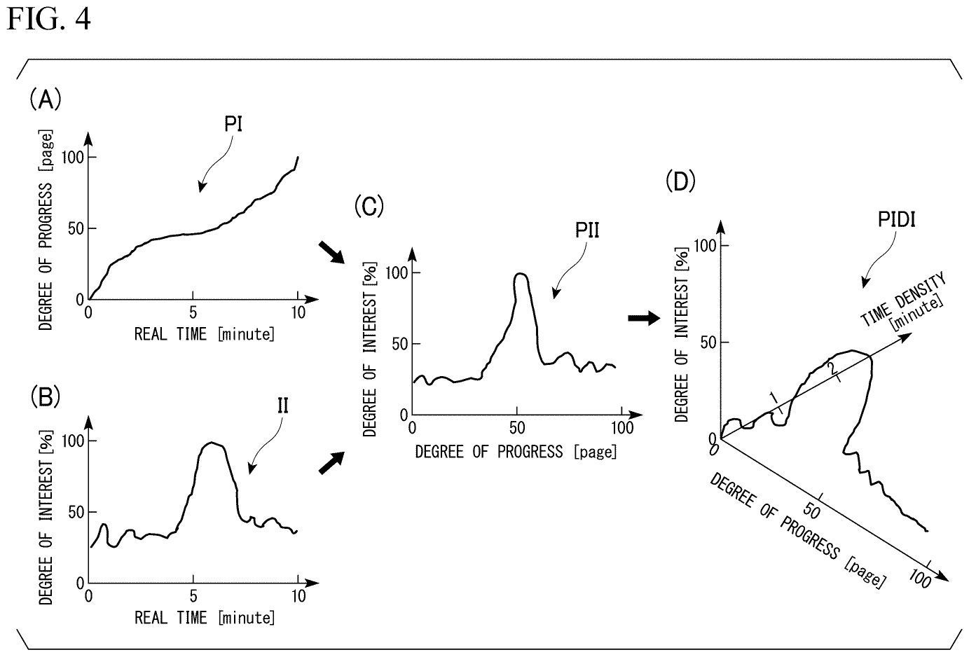

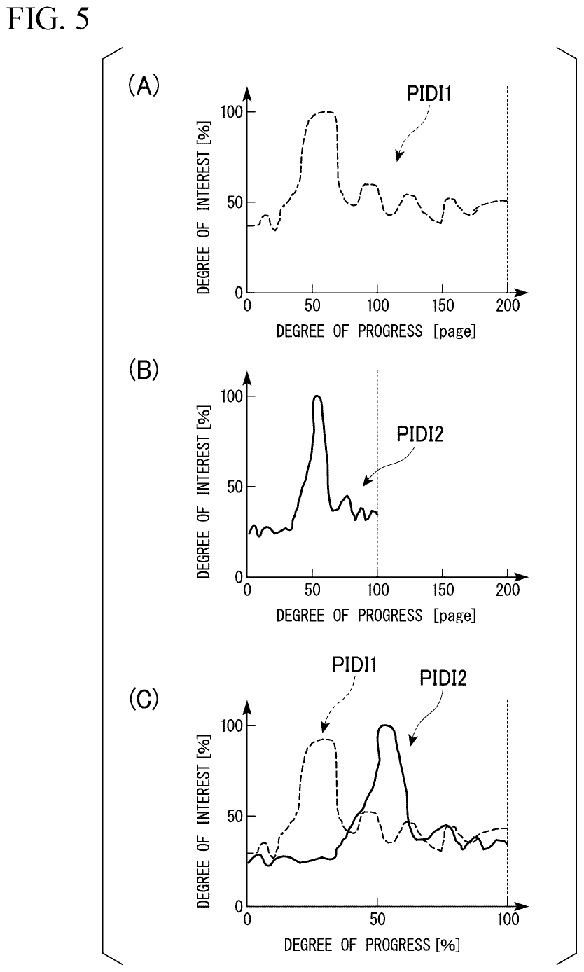

FIG. 3 is a functional configuration diagram illustrating an example of a functional configuration of the content interest degree processing device according to the embodiment. FIG. 4 is a diagram illustrating an example of a process flow of generating content time density information that is performed by the content interest degree processing device 40 according to the embodiment. FIG. 5 is a diagram illustrating normalization of the content interest degree information PII in the content interest degree processing device 40 according to the embodiment. An example of a configuration of the content interest degree processing device 40 and a process flow that is performed by the content interest degree processing device 40 will be described below with reference to FIGS. 3 to 5. The content interest degree processing device 40 includes a progress degree acquiring unit 41, an interest degree acquiring unit 42, a content interest degree information generating unit 43, a time density information generating unit 44, a content time density information generating unit 45, a normalization unit 46, and an output unit 47. These functional units are realized, for example, using a computer and software. The functional units may be realized using electronic circuits according to necessity. The functional units may not be included in a single device, and the content interest degree processing device 40 may be constituted by a plurality of devices.

The progress degree acquiring unit 41 acquires progress degree information PI from the terminal device 20 via the network NW. The progress degree acquiring unit 41 transmits the acquired progress degree information PI to the content interest degree information generating unit 43. The progress degree acquiring unit 41 transmits the acquired progress degree information PI to the time density information generating unit 44. The progress degree information PI is information indicating a correlation between a degree of progress and a real time. The progress degree information PI is, for example, information with a degree of progress [page] as a first axis and the real time [minute] as a second axis indicating a correlation therebetween as illustrated in FIG. 4(A). The progress degree acquiring unit 41 acquires the progress degree information PI by inquiring about a degree of progress of content (what page the user is currently reading) every predetermined time (for example, 1 second). The inquiry may be performed as an internal process of the terminal device 20 or may be performed by the content interest degree processing device 40. The progress degree acquiring unit 41 may acquire the progress degree information PI by inquiring about a time required for progress of the content (a time required for the user to read one page) every predetermined degree of progress (for example, every page).

The interest degree acquiring unit 42 acquires the interest degree information II from the terminal device 20 via the network NW. The interest degree acquiring unit 42 transmits the acquired interest degree information II to the content interest degree information generating unit 43. The interest degree information II is information indicating a correlation between a degree of interest and the real time. The interest degree information II is, for example, information with a degree of interest [%] as a first axis and the real time [minute] as a second axis indicating a correlation therebetween as illustrated in FIG. 4(B). The interest degree acquiring unit 42 acquires a degree of interest, for example, by monitoring information on autonomic neural activity of the user. The information on the autonomic neural activity of the user may be, for example, physical quantities emitted from a human body such as a heart beat, brain waves, an electro-oculogram, the electrodermal activity, the skin temperature, and an electromyogram. Biological information of the user may be acceleration information acquired by an acceleration sensor (not illustrated) included in the terminal device 20. The degree of interest may be information which is acquired through calculation of a plurality of pieces of information of such information.

The content interest degree information generating unit 43 acquires the progress degree information PI from the progress degree acquiring unit 41. The content interest degree information generating unit 43 acquires the interest degree information II from the interest degree acquiring unit 42. The content interest degree information generating unit 43 generates the content interest degree information PII by correlating the degree of progress and the degree of interest on the basis of the real time of the acquired progress degree information PI and the acquired interest degree information II. Specifically, the content interest degree information generating unit 43 may generate the content interest degree information PII by correlating the degree of progress and the degree of interest in the same real time. The content interest degree information generating unit 43 transmits the generated content interest degree information PII to the content time density information generating unit 45. The content interest degree information PII is, for example, information with a degree of interest [%] as a first axis and a degree of progress [page] as a second axis indicating a correlation therebetween as illustrated in FIG. 4(C). In the course of generating the content interest degree information PII in which the degree of progress and the degree of interest are correlated on the basis of the real time, information on the real time may not be included. In order to use the information on the real time not included to evaluate a part in which the user's mental state changes in the content, the content time density information generating unit 45 which will be described later additionally correlates the content interest degree information PII with information based on the real time.

FIG. 4 illustrates an example in which the content interest degree information generating unit 43 generates the content interest degree information PII on the basis of a real-time change of the degree of progress included in the progress degree information PI and a real-time change of the degree of interest included in the interest degree information II. However, the present embodiment is not limited to this example. The content interest degree information generating unit 43 may generate the content interest degree information PII by correlating the acquired degree of progress with the information on the real-time change of the degree of interest acquired by the interest degree acquiring unit 42 at the timing at which the progress degree acquiring unit 41 acquires the degree of progress. When the degree of progress is correlated with the information on the real-time change of the degree of interest, the progress degree information PI does not necessarily have a structure in which the degree of progress and the real time are correlated.

In the present embodiment, an example in which the content interest degree information generating unit 43 generates the content interest degree information PII by correlating the degree of progress and the degree of interest in the same real time is described. However, the present embodiment is not limited to this example. The content interest degree information generating unit 43 may generate the content interest degree information PII by deriving an expression indicating a correlation between a degree of progress and a degree of interest on the basis of the interest degree information II and the progress degree information PI. Specifically, the content interest degree information generating unit 43 calculates an expression indicating the correlation between the degree of interest and the real time from the interest degree information II. The content interest degree information generating unit 43 calculates an expression indicating a correlation between the degree of progress and the real time from the progress degree information PI. The content interest degree information generating unit 43 may generate the content interest degree information PII by deriving the expression indicating the correlation between the degree of progress and the degree of interest on the basis of the expression indicating the degree of interest and the real time and the expression indicating the correlation between the degree of progress and the real time.

The time density information generating unit 44 acquires the progress degree information PI from the progress degree acquiring unit 41. The time density information generating unit 44 generates time density information DI on the basis of the acquired progress degree information PI. The time density information DI includes information on a time required for the user to view a predetermined number of groups G or elements E (which may be hereinafter referred to as a time density). The time density information generating unit 44 transmits the acquired time density information DI to the content time density information generating unit 45. Specifically, the time density information DI may include information on a time required to increase the degree of progress of the content by 1 [%] or may include a time required to read the content 1 [scene], 1 [page], 10 [page], or 1 [volume]. When the user views the content back to a predetermined degree of progress, the time required for first viewing of the content with the degree of progress and the time required for second viewing of the content may be summed to generate the time density information DI.

The content time density information generating unit 45 acquires the content interest degree information PII from the content interest degree information generating unit 43. The content time density information generating unit 45 acquires the time density information DI from the time density information generating unit 44. The content time density information generating unit 45 generates content time density information PIDI by correlating the acquired content interest degree information PII with the time density information DI. The content time density information PIDI is, for example, information with a degree of interest [%] as a first axis, a degree of progress [page] as a second axis, and the real time [minute] as a third axis indicating a correlation therebetween as illustrated in FIG. 4(D). The content time density information generating unit 45 transmits the generated content time density information PIDI to the normalization unit 46.

The normalization unit 46 acquires the content time density information PIDI from the content time density information generating unit 45. The normalization unit 46 normalizes the acquired content time density information PIDI. For example, the normalization unit 46 may normalize the degree of progress in the content time density information PIDI using a value of from 0[%] to 100[%]. The normalization unit 46 transmits the normalized content time density information PIDI (which may be hereinafter referred to as normalized information NI) to the output unit 47.

An example in which the content time density information PIDI is normalized by the normalization unit 46 will be described with reference to FIG. 5. This drawing illustrates an example in which the degree of progress in the content time density information PIDI is normalized. In description with reference to the drawing, the time density will be omitted for the purpose of simplification. In FIG. 5(A) to 5(C), the first axis represents the degree of interest [%], and the second axis represents the degree of progress. FIG. 5(A) illustrates an example of information in which a degree of progress of content with 200 [page] and a degree of interest of the user at the degree of progress are correlated (which may be hereinafter referred to as content time density information PIDI1). FIG. 5(B) illustrates an example of information in which a degree of progress of content with 150 [page] and a degree of interest of the user at the degree of progress are correlated (which may be hereinafter referred to as content time density information PIDI2). Since the content time density information PIDI1 and the content time density information PIDI2 are different in the maximum value of the degree of progress from each other, comparison therebetween may be difficult. In order to facilitate comparison between a plurality of pieces of content time density information PIDI which are different in the maximum value of the degree of progress from each other, the normalization unit 46 normalizes the minimum value and the maximum value of the degree of progress in the content time density information PIDI. FIG. 5(C) illustrates examples of the content time density information PIDI1 and the content time density information PIDI2 normalized using a value of from 0[%] to 100[%] with the ratio of the groups G or elements E presented to the user to the whole content as the degree of progress. In FIG. 5(C), for example, the content time density information PIDI1 indicates that a part in which the user's mental state changes is present in the first half of the content. On the other hand, the content time density information PIDI2 indicates that a part in which the user's mental state changes is present in the middle of the content, whereby comparison can be performed. In this way, by normalizing the degree of progress of the content time density information PIDI, it is possible to easily compare the content time density information PIDI between the plurality of pieces of content regardless of the maximum value of the degree of progress of the content (for example, the number of pages in the content). By normalizing the value of the degree of progress of the content using the ratio of the groups G or elements E presented to the user to the whole content, it is possible to compare a plurality of pieces of content in which units of the degree of progress are different.

An example in which the normalization unit 46 normalizes the degree of progress using a value of from 0[%] to 100[%] is described above. However, the present embodiment is not limited to this example. The normalization unit 46 may normalize the minimum value and the maximum value of the degree of progress using a value of a standard degree of progress for each piece of content. For example, in case of a cartoon which are prepared with more or less than 200 [page], the value of standard degree of progress for each piece of content may range from 0 [page] to 200 [page]. By normalizing degrees of progress of a plurality of popular cartoons and collecting information of the degree of progress (page) in which details for changing the user's mental state are described, it is possible to analyze of what page the details for changing a user's mental state are described in the vicinity. That is, by causing the normalization unit 46 to normalize the degree of progress according to content, it is possible to analyze a timing at which the details for changing a user's mental state are described on the basis of the content time density information PIDI. With this analysis, when a new cartoon is prepared, it is possible to easily predict that of what page the details for changing a user's mental state are described in the vicinity is likely to be popular.

In description with reference to FIG. 5, an example in which the normalization unit 46 normalizes the degree of progress in the content time density information PIDI is described. However, the present embodiment is not limited to this example. The normalization unit 46 may normalize the time density in the content time density information PIDI or may normalize the degree of progress and the time density. For example, the normalization unit 46 may normalize a value of the time density using the ratio of a time required to increase the degree of progress by 1[%] to a time required to view the whole content. By normalizing the time density in a plurality of pieces of content with different times required to increase the degree of progress by 1[%] such as a book and a cartoon, it is possible to easily compare the content time density information PIDI regardless of the time required to increase the degree of progress between the pieces of content.

The output unit 47 acquires normalized information NI from the normalization unit 46. The output unit 47 outputs the acquired normalized information NI. By using the normalized information NI, it is possible to evaluate a user's mental state about content regardless of individual differences in the progress speed of content between users.

An example in which the interest degree information II includes information on a degree of interest is described above. However, the present embodiment is not limited to this example. The interest degree information II may include information indicating a mental state of the user to whom the content has been presented. Specifically, the interest degree information II may include information on a mental state such as [comfort-discomfort], [pleasure-sadness], [anger-fear], [like-dislike], or [comfort-surprise] which is felt from the presented content by a user. The interest degree information II may include, for example, information on a degree of concentration of a user on content.

In the aforementioned description, the progress degree information PI is information of a graph with the degree of progress [page] as a first axis and with the real time [minute] as a second axis. However, the present embodiment is not limited to this example. The progress degree information PI may have a format such as comma separated value (CSV) as long as the degree of progress and the real time are correlated. The same is true of the interest degree information II, the content interest degree information PII, the content time density information PIDI, and the normalized information NI.

### Summary of content interest degree processing device 40

According to the aforementioned embodiment, the content interest degree processing device 40 includes: the progress degree acquiring unit 41 configured to acquire progress degree information PI on a degree of progress of content which progresses on the basis of a user's operation; the interest degree acquiring unit 42 configured to acquire interest degree information II including information on a real-time change of a degree of interest of a user to whom the content has been presented in the content; and the content interest degree information generating unit 43 configured to generate content interest degree information PII in which the progress degree information PI acquired by the progress degree acquiring unit 41 and the real-time change of the degree of interest acquired by the interest degree acquiring unit 42 are correlated. Here, in case of content which progresses on the basis of a user's operation, since the progress speed of content varies depending on users, it may be difficult to identify a part in which a user is interested in the content on the basis of the real-time change of the degree of interest according to the related art. The content interest degree information generating unit 43 according to the embodiment generates information in which the degree of interest and the degree of progress are correlated. By causing the content interest degree information generating unit 43 to generate the information in which the degree of interest and the degree of progress are correlated, it is possible to identify a part in which a user is interested in the content on the basis of information not depending on individual differences of the progress speed of the content between users such as the degree of progress. Accordingly, according to the embodiment, the content interest degree processing device 40 can evaluate a user's mental state about content regardless of individual differences of the progress speed of the content between users.

According to the aforementioned embodiment, the content interest degree processing device 40 further includes the content time density information generating unit 45 configured to, when the content is divided into a plurality of units, generate content time density information PIDI by correlating a time density indicating a time required for progress of one unit with the content interest degree information PII. Since the content time density information generating unit 45 generates the content interest degree information PII in which the degree of interest and the degree of progress are correlated, the content interest degree information PII does not include information on the time required for the user to view a group G or element E included in the progress degree information PI. According to the embodiment, the content time density information generating unit 45 correlates the content interest degree information PII in which the degree of interest and the degree of progress are correlated with the time density information DI on the time additionally required to view a predetermined number of groups G or elements E. The content interest degree processing device 40 can identify a part in which a user is interested in the content on the additional basis of the time required for the user to view the groups G or elements E by correlating the content interest degree information PII with the time density information DI. Accordingly, the content interest degree processing device 40 according to the embodiment can evaluate a user's mental state about the content on the basis of the progress speed of the content by the user.

According to the aforementioned embodiment, in the content interest degree processing device 40, the progress degree information PI includes information on a real-time change of the degree of progress, and the content interest degree information generating unit 43 generates the content interest degree information PII by correlating the real-time change of the degree of progress acquired by the progress degree acquiring unit 41 with the real-time change of the degree of interest acquired by the interest degree acquiring unit 42. In case of content which progresses on the basis of a user's operation, since a progress speed of the content varies depending on users, it may be difficult to identify a part in which a user is interested in the content on the basis of the real-time change of the degree of interest. The content interest degree information generating unit 43 according to the embodiment generates information in which the degree of interest and the degree of progress are correlated on the basis of the real-time change. By generating the information in which the degree of interest and the degree of progress are correlated, it is possible to identify a part in which a user is interested in the content on the basis of information not depending on individual differences of the progress speed of the content between users such as the degree of progress. Accordingly, according to the embodiment, the content interest degree processing device 40 can evaluate a user's mental state about the content regardless of individual differences of the progress speed of the content between users.

According to the aforementioned embodiment, in the content interest degree processing device 40, the degree of interest is based on a value which is acquired according to the autonomic neural activity of the user to whom the content has been presented. According to the embodiment, the content interest degree processing device 40 can accurately evaluate a user's mental state about the content by acquiring the degree of interest of the user in the content on the basis of the user's autonomic neural activity.

According to the aforementioned embodiment, the content interest degree processing device 40 further includes the normalization unit 46 configured to normalize the degree of progress in a plurality of pieces of the content interest degree information PII generated by the content interest degree information generating unit 43 when there are a plurality of pieces of content. Since a plurality of pieces of content including different numbers of groups G or elements E are different in a maximum value and a minimum value of the degree of progress, it may be difficult to compare parts in which a user is interested in the plurality of pieces of content on the basis of the degree of progress. By causing the normalization unit 46 to normalize the value of the degree of progress of the content, it is possible to compare parts in which a user is interested in a plurality of pieces of content regardless of the number of groups G or elements E included in the pieces of content. Accordingly, according to the embodiment, the content interest degree processing device 40 can compare parts in which a user is interested in a plurality of pieces of content regardless of the number of groups G or elements E included in the pieces of content.

According to the aforementioned embodiment, in the content interest degree processing device 40, when the content is divided into a plurality of units, the units into which the content is divided are presented to the user one by one, and the progress degree information PI includes information indicating the degree of progress of each unit based on identification information for identifying each unit. In case of content which progresses on the basis of a user's operation, since the progress speed of content varies depending on users, it may be difficult to identify a part in which a user is interested in the content on the basis of the real-time change of the degree of interest. The progress degree acquiring unit 41 acquires the degree of progress on the basis of information for identifying the group G which is each divided unit. The content interest degree processing device 40 can accurately ascertain a part which is presented to the user by acquiring the degree of progress on the basis of the divided units. By accurately ascertaining the part which is presented to the user, the content interest degree processing device 40 can identify a part in which a user is interested in the content on the basis of the degree of interest and the degree of progress. Accordingly, according to the embodiment, the content interest degree processing device 40 can evaluate a user's mental state about the content regardless of individual differences of the progress speed of the content divided into a plurality of units between users.

According to the aforementioned embodiment, in the content interest degree processing device 40, when the content is divided into a plurality of units, identification information for identifying each of the units into which the content is divided is provided, and the progress degree information PI includes information indicating the degree of progress of each unit based on the identification information. In case of content which progresses on the basis of a user's operation, since the progress speed of content varies depending on users, it may be difficult to identify a part in which a user is interested in the content on the basis of the real-time change of the degree of interest. The progress degree acquiring unit 41 acquires the degree of progress on the basis of information for identifying the group G or element E which is each divided unit. The content interest degree processing device 40 can accurately ascertain a part which is presented to the user by acquiring the degree of progress on the basis of the divided units. By accurately ascertaining the part which is presented to the user, the content interest degree processing device 40 can identify a part in which a user is interested in the content on the basis of the degree of interest and the degree of progress. Accordingly, according to the embodiment, the content interest degree processing device 40 can evaluate a user's mental state about the content regardless of individual differences of the progress speed of the content between users. As a result, according to the embodiment, the content interest degree processing device 40 can evaluate a user's mental state about the content regardless of individual differences of the progress speed of the content divided into a plurality of units between users.

### Second Content

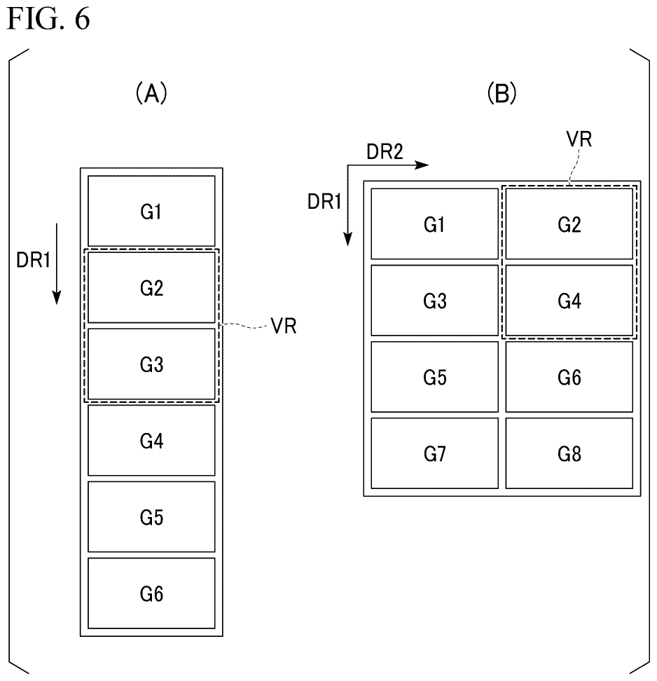

FIG. 6 is a second diagram illustrating an example of content according to the embodiment. The degree of progress of the second content will be described below with reference to the drawing. The second content is the same as the first content in that the second content includes a plurality of groups G. The second content is different from the first content in that a user views the groups G by moving a viewing range VR. The viewing range VR is a presentation range presented to a user in the content. The number of groups G in the second content may vary depending on content that is presented to a user similarly to the number of groups G in the first content. Specifically, the number of groups G constituting content may be preset to, for example, 10 or 20 or may be changed on the basis of a user's operation. The second content is displayed, for example, on a display of a smartphone, a tablet terminal device, or the like. The second content may be content which is provided by a scroll-type cartoon reader or may be content which is displayed by SNS. Each group G may be an image or a video.

FIG. 6(A) and 6(B) illustrate examples of the second content. A user views the second content illustrated in FIG. 6(A) by moving the viewing range VR in a positive direction (downward) or a negative direction (upward) of a first direction DR1. The second content illustrated in FIG. 6(A) may be content which is provided by a vertical scroll-type cartoon reader or may be content which is displayed by SNS. A user views the second content illustrated in FIG. 6(B) by additionally moving the viewing range VR in a positive direction (rightward) or a negative direction (leftward) of a second direction DR2. A user may move the viewing range VR in a direction other than the first direction DRI and the second direction DR2. That is, a user may obliquely move the viewing range VR. The second content illustrated in FIG. 6(B) may be content with a large amount of information corresponding to one page such as a magazine book which is provided by an electronic book reader.

The degree of progress of the second content is a value based on information for identifying each group G which is presented to a user using the viewing range VR. For example, the degree of progress may be a value based on an identification number or the like for identifying a group G which is currently presented to a user or may be the ratio of a group G which is presented to a user using the viewing range VR to the whole content. For example, the degree of progress may be a distance by which the viewing range VR moves in a movable distance of the viewing range VR. The distance may be a distance in one direction when the viewing range can move in two directions including the first direction DR1 and the second direction DR2.

According to the aforementioned embodiment, in the content interest degree processing device 40, when parts of the content are sequentially presented to a user, information included in the viewing range VR in information included in the content is presented to the user by moving the viewing range VR of the content in a predetermined direction on the basis of the user's operation, and the degree of progress is based on the ratio of the information included in the viewing range VR to the information included in the content. In case of content which progresses on the basis of a user's operation, since the progress speed of content varies depending on users, it may be difficult to identify a part in which a user is interested in the content on the basis of the real-time change of the degree of interest. The progress degree acquiring unit 41 according to the embodiment acquires the degree of progress based on the ratio of information included in the viewing range VR to information included in the content. The content interest degree processing device 40 can accurately ascertain a part which is presented to the user by acquiring the degree of progress based on the ratio. By accurately ascertaining the part which is presented to the user, the content interest degree processing device 40 can identify a part in which a user is interested in the content on the basis of the degree of interest and the degree of progress. Accordingly, according to the embodiment, the content interest degree processing device 40 can evaluate a user's mental state about the content regardless of individual differences of the progress speed of the content divided into a plurality of units between users.

### Third Content

Third content (not illustrated) is content of a video of which a reproduction speed changes. In the third content, for example, a reproduction speed of content as a whole may change, or a reproduction speed of a part which is viewed may change partially. The change of the reproduction speed may be performed on the basis of a user's operation or may be performed on the basis of a predetermined determination result from a device. The predetermined determination in a device may be, for example, determination based on a degree of concentration of a user.

The degree of progress of the third content is a value based on information for identifying a frame which is currently presented to a user. For example, the degree of progress may be a value based on an identification number or the like for identifying a frame which is presented to a user or may be a value based on the ratio of a scale from starting of a video to a part which is currently viewed by a user to a scale of the whole video.

According to the aforementioned embodiment, in the content interest degree processing device 40, a time required for the user to view a video of the content presented to the user is able to be changed by the user, and the progress degree information PI includes information on the degree of progress based on the ratio of a scale of the content from start of the video to a part currently viewed by the user to a scale of the whole video. In case of content which progresses on the basis of a user's operation, since the progress speed of content varies depending on users, it may be difficult to identify a part in which a user is interested in the content on the basis of the real-time change of the degree of interest. The progress degree acquiring unit 41 according to the embodiment acquires the degree of progress bsaed on the ratio of a scale from starting of a video to a part which is currently viewed by a user to the a scale of the whole video. The content interest degree processing device 40 can accurately ascertain a part which is presented to the user by acquiring the degree of progress based on the ratio. By accurately ascertaining the part which is presented to the user, the content interest degree processing device 40 can identify a part in which a user is interested in the content on the basis of the degree of interest and the degree of progress. Accordingly, according to the embodiment, the content interest degree processing device 40 can evaluate a user's mental state about the content regardless of individual differences of the progress speed of the content divided into a plurality of units between users.

### Terminal Device

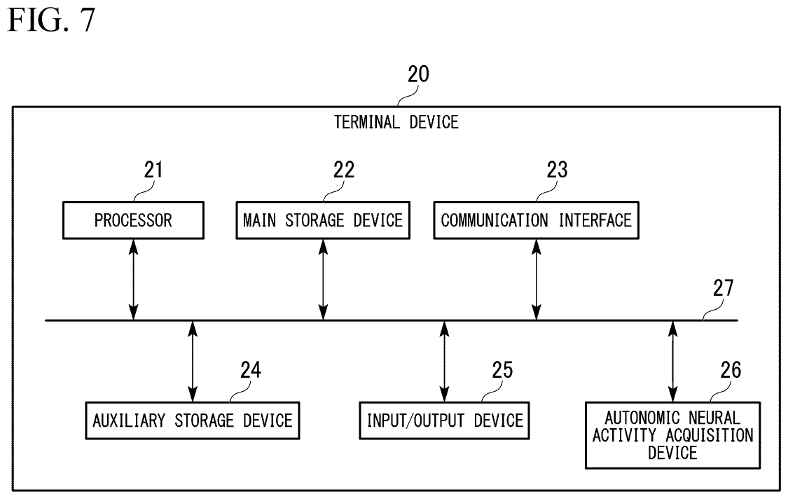

An example in which a terminal device 20 operates as the content interest degree processing device 40 by executing a predetermined algorithm will be described below with reference to FIGS. 7 to 9.

### Hardware of Terminal Device

FIG. 7 is a diagram illustrating an example of a terminal device that operates as the content interest degree processing device according to the embodiment. An example of hardware constituting a terminal device 20 that operates as the content interest degree processing device 40 will be described below with reference to the drawings. As illustrated in FIG. 7, the terminal device 20 includes a processor 21, a main storage device 22, a communication interface 23, an auxiliary storage device 24, an input/output device 25, an autonomic neural activity acquisition device 26, and a bus 27.

The processor 21 includes, for example, a central processing unit (CPU) and realizes functions of the content interest degree processing device 40 by reading and executing a program.

The main storage device 22 is, for example, a random access memory (RAM) and stores a program which is read and executed by the processor 21 in advance.

The communication interface 23 is an interface circuit for performing communication with another device via a network. The network is, for example, the Internet, intranet, a wide area network (WAN), or a local area network (LAN).

The auxiliary storage device 24 is, for example, a hard disk drive, a solid state drive, or a flash memory.

The input/output device 25 is, for example, an input/output port. For example, a mouse, a keyboard, and a display are connected to the input/output device 25. The mouse and the keyboard receive, for example, an operation for viewing content. The display is, for example, a liquid crystal display. The display displays, for example, content. The input/output device 25 may receive an operation by allowing a user to touch the display (that is, a user may perform an input operation using a touch panel).

The autonomic neural activity acquisition device 26 acquires autonomic neural activity information AAI on autonomic neural activity of a user to whom content is presented. The autonomic neural activity information AAI is information on a value based on autonomic neural activity of a user who views content. The autonomic neural activity information AAI includes, for example, physical quantities emitted from a human body such as pulse waves, a heart beat, brain waves, an electro-oculogram, the electrodermal activity, the skin temperature, and an electromyogram. The autonomic neural activity acquisition device 26 is, for example, a camera, an acceleration sensor, a pulsimeter, an electronystagmography, a stabilometer, an electromyography, a thermometer, or a magnetoencephalography.

The bus 27 connects the processor 21, the main storage device 22, the communication interface 23, the auxiliary storage device 24, the input/output device 25, and the autonomic neural activity acquisition device 26 such that they can perform data communication with each other.

### Functional Configuration of Terminal Device

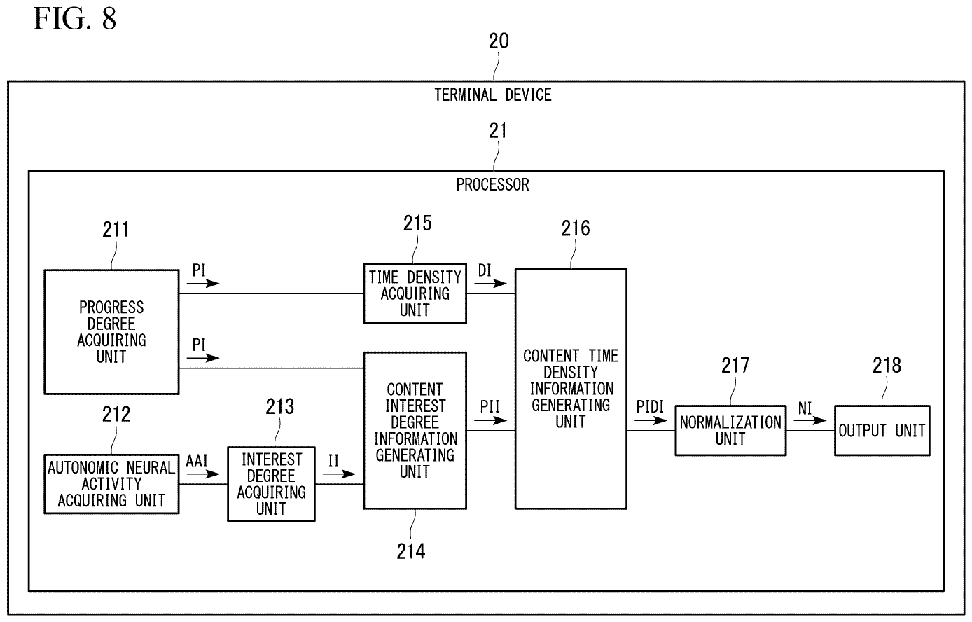

A functional configuration of the terminal device 20 that operates as the content interest degree processing device 40 will be described below with reference to FIG. 8.

FIG. 8 is a diagram illustrating an example of a functional configuration of a terminal device according to the embodiment. The functional configuration of the terminal device 20 will be described below with reference to the drawing. The terminal device 20 includes a progress degree acquiring unit 211, an autonomic neural activity acquiring unit 212, an interest degree acquiring unit 213, a content interest degree information generating unit 214, a time density acquiring unit 215, a content time density information generating unit 216, a normalization unit 217, and an output unit 218 as software functional units or hardware functional units of the processor 21.

The progress degree acquiring unit 211 acquires progress degree information PI. The progress degree acquiring unit 211 may acquire progress degree information PI, for example, when content progresses. Specifically, the progress degree acquiring unit 211 may acquire a page number when a user has turned the page of content such as a book, a magazine, or a cartoon. The progress degree acquiring unit 211 may acquire a degree of progress every predetermined time (for example, every second). The progress degree acquiring unit 211 transmits the acquired progress degree information PI to the content interest degree information generating unit 214. The progress degree acquiring unit 211 transmits the progress degree information PI to the time density acquiring unit 215.

The autonomic neural activity acquiring unit 212 acquires autonomic neural activity information AAI from the autonomic neural activity acquisition device 26. The autonomic neural activity acquiring unit 212 transmits the acquired autonomic neural activity information AAI to the interest degree acquiring unit 213.

The interest degree acquiring unit 213 acquires information indicating a user's mental state on the basis of the autonomic neural activity information AAI acquired from the autonomic neural activity acquiring unit 212. For example, the interest degree acquiring unit 213 acquires interest degree information II on a real-time change of a degree of interest of a user in the content. The interest degree acquiring unit 213 transmits the acquired interest degree information II to the content interest degree information generating unit 214. The interest degree information II may include information on a mental state such as [comfort-discomfort], [pleasure-sadness], [anger-fear], [like-dislike], or [comfort-surprise] which is felt from the presented content by a user. The interest degree information II may include, for example, information on a degree of concentration of a user on the content.

The content interest degree information generating unit 214 acquires progress degree information PI from the progress degree acquiring unit 211. The content interest degree information generating unit 214 acquires interest degree information II from the interest degree acquiring unit 213. The content interest degree information generating unit 214 generates content interest degree information PII by correlating the degree of progress and the degree of interest on the basis of the acquired progress degree information PI and the acquired interest degree information II. The content interest degree information generating unit 214 transmits the generated content interest degree information PII to the content time density information generating unit 216.

The time density acquiring unit 215 acquires progress degree information PI from the progress degree acquiring unit 211. The time density acquiring unit 215 generates time density information DI on the basis of the acquired progress degree information PI. The time density acquiring unit 215 transmits the generated time density information DI to the content time density information generating unit 216.

The content time density information generating unit 216 acquires content interest degree information PII from the content interest degree information generating unit 214. The content time density information generating unit 216 acquires time density information DI from the time density acquiring unit 215. The content time density information generating unit 216 generates content time density information PIDI by correlating the acquired content interest degree information PII and the acquired time density information DI. The content time density information generating unit 216 transmits the generated content time density information PIDI to the normalization unit 217.

The normalization unit 217 acquires the content time density information PIDI from the content time density information generating unit 216. The normalization unit 217 normalizes the acquired content time density information PIDI. The normalization unit 217 transmits the normalized content time density information PIDI (normalized information NI) to the output unit 218.

The output unit 218 acquires the normalized information NI from the normalization unit 217. The output unit 218 outputs the acquired normalized information NI. By using the normalized information NI, it is possible to evaluate a user's mental state about content regardless of individual differences of the progress speed of the content between users.

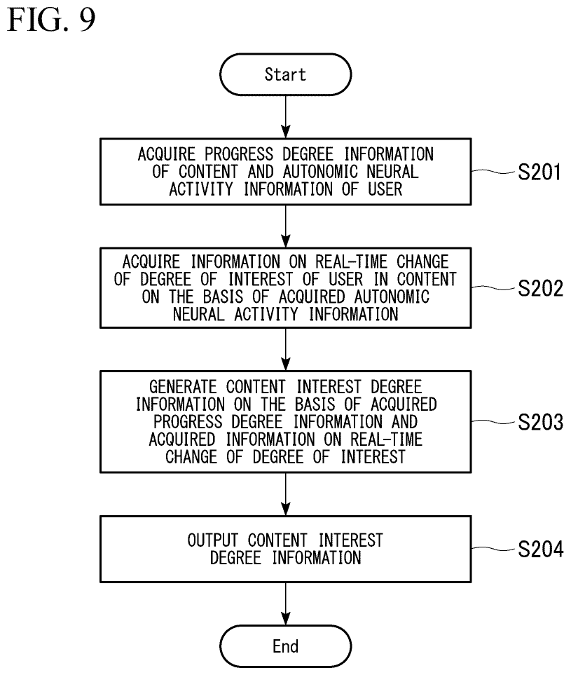

FIG. 9 is a flowchart illustrating an example of a process flow that is performed by the terminal device according to the embodiment. An example of a process flow that is performed by the terminal device 20 will be described below with reference to the drawing.

(Step S201) The terminal device 20 acquires progress degree information PI on a degree of progress of content and autonomic neural activity information AAI which is a value based on a user's autonomic neural activity.

(Step S202) The terminal device 20 acquires interest degree information II on a real-time change of the degree of interest of a user in a category on the basis of the acquired autonomic neural activity information AAI.

(Step S203) The terminal device 20 generates content interest degree information PII on the basis of the acquired progress degree information PI and the acquired interest degree information II on the real-time change of the degree of interest. (Step S204) The terminal device 20 outputs the generated content interest degree information PII.

### Summary of Terminal Device

According to the aforementioned embodiment, the terminal device 20 includes: the progress degree acquiring unit 211 configured to acquire progress degree information PI on a degree of progress of content which progresses on the basis of a user's operation; the interest degree acquiring unit 213 configured to acquire a real-time change of a degree of interest of a user to whom the content has been presented in the content; the time density acquiring unit 215 configured to generate content interest degree information PII in which the progress degree information PI acquired by the progress degree acquiring unit 211 and the real-time change of the interest degree information II acquired by the interest degree acquiring unit 213 are correlated; and the output unit 218 configured to output the content interest degree information PII. In case of content which progresses on the basis of a user's operation, since the progress speed of content varies depending on the user, it may be difficult to identify a part in which a user is interested in the content on the basis of the real-time change of the degree of interest. The terminal device 20 according to the embodiment generates information in which the degree of interest and the degree of progress are correlated. By generating the information in which the degree of interest and the degree of progress are correlated, it is possible to identify a part in which a user is interested in the content on the basis of information not depending on individual differences of the progress speed of the content between users such as the degree of progress. Accordingly, according to the embodiment, the terminal device 20 can evaluate a user's mental state about content regardless of individual differences of the progress speed of the content between users.

According to the aforementioned embodiment, the terminal device 20 further includes the autonomic neural activity acquiring unit 212 configured to acquire a value based on the autonomic neural activity of the user to whom the content has been presented, and the interest degree acquiring unit 213 acquires the real-time change of the degree of interest on the basis of the value acquired by the autonomic neural activity acquiring unit 212. In case of content which progresses on the basis of a user's operation, since the progress speed of content varies depending on users, it may be difficult to identify a part in which a user is interested in the content on the basis of the real-time change of the degree of interest. The terminal device 20 according to the embodiment generates information in which the degree of interest and the degree of progress are correlated. By generating the information in which the degree of interest and the degree of progress are correlated, it is possible to identify a part in which a user is interested in the content on the basis of information not depending on individual differences of the progress speed of the content between users such as the degree of progress. Accordingly, according to the embodiment, the terminal device 20 can evaluate a user's mental state about content regardless of individual differences of the progress speed of the content between users.

All or some functions of the constituents of the content interest degree processing device 40 and the terminal device 20 according to the aforementioned embodiment may be realized by recording a program for realizing these functions on a computer-readable recording medium and causing a computer system to read and execute the program recorded on the recording medium. The “computer system” mentioned herein includes an operating system (OS) or hardware such as peripherals.

The “computer-readable recording medium” means a portable medium such as a flexible disk, a magneto-optical disc, a ROM, or a CD-ROM or a storage device such as a hard disk incorporated into a computer system. The “computer-readable recording medium” may include a medium that dynamically holds a program for a short time such as a communication line when the program is transmitted via a network such as the Internet or a communication circuit line such as a telephone line and a medium that holds a program for a predetermined time such as a volatile memory in a computer system serving as a server or a client in that case. The program may be a program for realizing some of the aforementioned functions or may be a program for realizing the aforementioned functions in combination with a program recorded in advance in the computer system.

While an embodiment of the present invention has been described above in detail with reference to the drawings, any specific configuration is not limited to the above description, and various modifications in design or the like can be made on the embodiment without departing from the gist of the present invention. The configurations described in the aforementioned embodiment and examples may be combined.

### INDUSTRIAL APPLICABILITY

According to the present invention, it is possible to evaluate a part in which a user's mental state changes in content regardless of individual differences in the progress speed of content between users.

### REFERENCE SIGNS LIST

G Group
E Element
1 System
20 Terminal device
40 Content interest degree processing device
41 Progress degree acquiring unit
42 Interest degree acquiring unit
43 Content interest degree information generating unit
44 Time density information generating unit
45 Content time density information generating unit
46 Normalization unit
47 Output unit
PI Progress degree information
II Interest degree information
PII Content interest degree information
DI Time density information
PIDI Content time density information
NI Normalization information
VR Visible range
DR1 First direction
DR2 Second direction
21 Processor
22 Main storage device
23 Communication interface
24 Auxiliary storage device
25 Input/output device
26 Autonomic neural activity acquisition device
27 Bus
211 Progress degree acquiring unit
212 Autonomic neural activity acquiring unit
213 Interest degree acquiring unit
214 Content interest degree information generating unit
215 Time density acquiring unit
216 Content time density information generating unit
217 Normalization unit
218 Output unit
AAI Autonomic neural activity information

1. A content interest degree processing device comprising:
a progress degree acquiring unit configured to acquire progress degree information on a degree of progress of content which progresses on the basis of a user's operation;
an interest degree acquiring unit configured to acquire a real-time change of a degree of interest of a user to whom the content has been presented in the content; and
a content interest degree information generating unit configured to generate content interest degree information in which the progress degree information acquired by the progress degree acquiring unit and the real-time change of the degree of interest acquired by the interest degree acquiring unit are correlated.

2. The content interest degree processing device according to claim 1, further comprising a content time density information generating unit configured to, when the content is divided into a plurality of units, generate content time density information by correlating a time density indicating a time required for progress of one unit with the content interest degree information.

3. The content interest degree processing device according to claim 1, wherein the progress degree information includes information on a real-time change of the degree of progress, and
wherein the content interest degree information generating unit generates the content interest degree information by correlating the real-time change of the degree of progress acquired by the progress degree acquiring unit with the real-time change of the degree of interest acquired by the interest degree acquiring unit.

4. The content interest degree processing device according to claim 1, wherein the degree of interest is based on a value which is acquired according to autonomic neural activity of the user to whom the content has been presented.

5. The content interest degree processing device according to claim 1, further comprising a normalization unit configured to normalize the degree of progress in a plurality of pieces of the content interest degree information generated by the content interest degree information generating unit when there are a plurality of pieces of content.

6. The content interest degree processing device according to claim 1, wherein, when the content is divided into a plurality of units, the units into which the content is divided are presented to the user one by one, and the progress degree information includes information indicating the degree of progress of each unit based on identification information for identifying each unit.

7. The content interest degree processing device according to claim 1, wherein, when the content is divided into a plurality of units, identification information for identifying each of the units into which the content is divided is provided, and the progress degree information includes information indicating the degree of progress of each unit based on the identification information.

8. The content interest degree processing device according to claim 1, wherein, when parts of the content are sequentially presented to the user, information included in a presentation range of the content in information included in the content is presented to the user by moving the presentation range in a predetermined direction on the basis of the user's operation, and
wherein the degree of progress is based on the ratio of the information included in the presentation range to the information included in the content.

9. The content interest degree processing device according to claim 1, wherein a time required for the user to view a video of the content presented to the user is able to be changed by the user, and
wherein the progress degree information includes information on the degree of progress based on the ratio of a scale of the content from start of the video to a part currently viewed by the user to a scale of the whole video.

10. A terminal device comprising:
a progress degree acquiring unit configured to acquire progress degree information on a degree of progress of content which progresses on the basis of a user's operation;
an interest degree acquiring unit configured to acquire a real-time change of a degree of interest of a user to whom the content has been presented in the content;
a content interest degree information generating unit configured to generate content interest degree information in which the progress degree information acquired by the progress degree acquiring unit and the real-time change of the degree of interest acquired by the interest degree acquiring unit are correlated; and
an output unit configured to output the content interest degree information.

11. The terminal device according to claim 10, further comprising an autonomic neural activity acquiring unit configured to acquire a value based on autonomic neural activity of the user to whom the content has been presented,
wherein the interest degree acquiring unit acquires the real-time change of the degree of interest on the basis of the value acquired by the autonomic neural activity acquiring unit.

12. A program causing a computer to perform:
a progress degree acquiring step of acquiring progress degree information on a degree of progress of content which progresses on the basis of a user's operation;
an interest degree acquiring step of acquiring a real-time change of a degree of interest of a user to whom the content has been presented in the content;
a content interest degree information generating step of generating content interest degree information in which the progress degree information acquired in the progress degree acquiring step and the real-time change of the degree of interest acquired in the interest degree acquiring step are correlated; and
an output step of outputting the content interest degree information.
